(19) United States
(12) Patent Application Publication
(10) Pub. No.: US 2003/0200131 A1
(43) Pub. Date: Oct. 23, 2003

(54) Personal style diagnostic system and method

(76) Inventor: James D. Gabbert, Eden Prairie, MN (US)

Correspondence Address: Fogg Slifer Polglaze Leffert & Jay, P.A., P.O. Box 581009, Minneapolis, MN, 55458-1009, US

(21) Appl. No.: 10/127,860

(22) Filed: Apr. 22, 2002

(51) Int. Cl. G06F 17/60

(52) U.S. Cl. 705/10

(57) ABSTRACT

A personal style diagnostic system uses a series of defined styles and a sliding scale of definitions and common language terminology within each style to provide a simple to use question and answer dialogue to facilitate the consumer's taste, style, and preferences for a room to be decorated.

### FIELD

The present invention relates generally to retail sales and assistance, and more specifically to evaluation and selection of style in retail sales, in the retail store, in the consumer's home, or on a website.

### BACKGROUND

Selection of furniture in a home often subjects the homeowner to a myriad of objects and components. Without the assistance of an interior designer or knowledgeable sales associate who is willing to work with the purchaser, many potential purchasers simply resort to choosing furniture on the basis of its price, proximity to them in the store, and other factors that do not reflect the style and comfort level of the purchaser. Few potential buyers can accurately describe their likes and dislikes. The language of retail furniture takes many forms, and these forms can be confusing, leading a potential purchaser to be swayed into buying furniture that does not reflect their desires and wants, but instead allows them to end the process of furniture shopping.

One's home can and should reflect the personality of its owners. But like each person, each home may have a personality, and many moods within that personality. Each room in the home can and should reflect different moods. The most satisfied customers are those whose styles are understood or defined, and whose moods and personalities are reflected in the rooms of the individual's home. The typical process for a designer or sales associate is intuitive and unstructured. The diagnostic systems currently in use to gauge the personality of an individual use a brief set of questions designed to place the individual's personality into one of only a few rather rigidly defined groups. Once the individual has been directed to a particular personality style, there is little room for variation. Further, many customers do not have the specialized furniture vocabulary for expressing their desires and wants.

Many significant roadblocks lie between the consumer and the successful creation of an envisioned beautiful home/room. The simple process of selecting and purchasing an item is often difficult and sometimes complicated. To bring together all the various subtle components that create a beautiful room can de daunting and is enormously complex as a project. Additionally, the complexity and time delays of working with the home furnishings industry often results in frustration. Home furnishings are a major investment that many people see as a ten-year or even a multigenerational investment. They do not wish to be shackled with a bad decision.

For the majority of the population it is difficult or even impossible to define or describe what they want their home to look like. Because of this difficulty, it often results in a lengthy search without consummating with a purchase. Or, it becomes an endless search process of looking for just the right piece that is never found because the consumer does not know what that right piece is. For many consumers, the entire furniture shopping process is filled with doubt, apprehension, and hesitation.

The only previous solution, as has been mentioned above, has been for the consumer to share the process with someone who has the skills to draw this out of the consumer intuitively. Professional interior designers are a natural answer. However, the services of the profession are not well understood. Many people choose not to use an interior designer for fear that their personal style will be overshadowed by the style of the interior designer. Many seek the advice and counsel of friends or relatives to be their guide.

There exists no common language for expressing one's personal vision for their home/room with others. Simply, words are too imprecise to communicate. The only methodology currently available is randomly identifying images from shelter magazines and using that as a communication tool. This approach is random and imprecise as well.

Typical style diagnostics operate on the assumption that personal style type is based upon personality type and once that personality type is determined, home decoration can be based on that. There is no known correlation with one's strictly defined personality and a style one prefers in a home. Homes are unique, like individuals, and the rooms within the home capture a variety of moods of that personality.

Therefore, there is a need in the art for a diagnostic tool that uses readily understood language and concepts of evaluation that allow more flexibility in the description of likes and dislikes, and which provides a representation of personal style that relies less on subjective personality assessment and more on actual feelings.

### SUMMARY

In one embodiment, a method for determining a personal style for a furniture shopper includes defining a number of style factors each having a range of components within the style factor, and evaluating the user's style factors along the range for each style factor. Once the user evaluation is complete, a composite style based on the defined style factors and the user's style factors is assigned.

In yet another embodiment, a method for evaluating personal style of a customer shopping for furniture includes creating a number of displayed rooms each having a style identified using style factors including formality, density, mix, brightness, and scale, querying the customer regarding preferences for or against each of the rooms, applying customer responses to the style of each room, and classifying the customer's personal style based on a compilation of the customer responses applied to the known style of each room.

In another embodiment, a personal style diagnostic system includes a computer having a computer program running thereon. The computer program contains definitions of a number of style factors, each having a range of components within the style factor. The program evaluates the user's style factors along the range for each style factor, and assigns a composite style based on the defined style factors and the user's style factors.

In still another embodiment, a data structure of furniture components is classified according to a predefined set of styles and ranges with those styles.

In yet another embodiment, a method for quantifying furniture needs and wants of a consumer includes defining a common language of terminology for use in style evaluation, defining a number of styles, each style having style factors including formality, density, mix, brightness, and scale, assigning a number of individual furniture components each to at least one of the styles, and within a range spectrum within each style, presenting the consumer with a subset of the individual furniture components, and evaluating a most common consumer preference along the range spectrum for each of the styles.

In still yet another embodiment, an intelligent furniture style selection agent includes a computer, a database of defined furniture components, each defined component identified within a range of at least one style category, a computer program to query a user regarding tastes for a subset of the defined furniture components and to interface, and an intelligent logic block to evaluate and refine style based on responses to the queries presented by the program.

Other embodiments are described and claimed.

### BRIEF DESCRIPTION OF DRAWINGS

FIG. 1 is a diagram of a personal style diagnostic system profile page;

FIG. 2 is a chart of a typical assignment of styles to basic room patterns and floor structures.

FIG. 3 is a diagram of a completed representative personal style diagnostic system profile page; and

FIG. 4 is a block diagram of a computer on which embodiments of the present invention are practiced.

### DETAILED DESCRIPTION

In the following detailed description of the embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Introduction—The Consumers' Problem

Often consumers simply do not know where to begin when decorating their home. The personal style diagnostic embodiments of the present invention are a comfortable and approachable place to begin. Often consumers are unwilling to put their trust in a sales professional because of their lack of confidence. The embodiments of the personal style diagnostic system provide a starting point that allows the consumer to explore personal style in a non-threatening way, creating or bolstering confidence for the remaining steps in the furniture buying process.

The embodiments of the personal style diagnostic system comfortably immerses the customer in the process of buying home furnishings. It provides a common ground from which the sales professional can move confidently to communicate with the customer. The more accurately the customer's needs and wants are understood, the less chance there is for costly returns and cancellation.

While the customer is being served the Personal Style Diagnostic accumulates a rich data base of all users that provides the retailer with valuable information concerning the styles and tendencies of the customer, to aid in product selection.

As a vendor partner the data base from the personal style diagnostic system embodiments is available to allow the manufacturer to better understand the consumer and their preferences, as well as for identification of trends and product development desires and avenues.

The personal style diagnostic system embodiments begin with an evaluation of the individual's style. Style differs from personality, and provides a unique approach to selection of furnishings for a room or home. The evaluation of style does not presume or assume to know what narrow category the customer fits into, but instead allows the customer, through a refinable evaluation process, to arrive comfortably and with increased confidence and knowledge to a reliable solution.

Introduction to the Personal Style Diagnostic System

The personal style diagnostic system embodiments of the present invention addresses the issues described above. The PSDS empowers the customer, providing the customer with knowledge and a means for expressing that knowledge, at the same time allowing a far greater range of choices and styles than previous rigid attempts to categorize customers into one of only a few styles based on personality. The PSDS provides a non-technical, familiar intuitive language of terms that facilitates clear communication for desired room personality, and assists not only in defining an interior design style but also the expression by the customer of that style. For a home occupied by more than one person, it provides the means for individuals to identify and share personal style preferences and resolve any differences before the design process begins, saving time and frustration and resulting in a more satisfactory outcome for all.

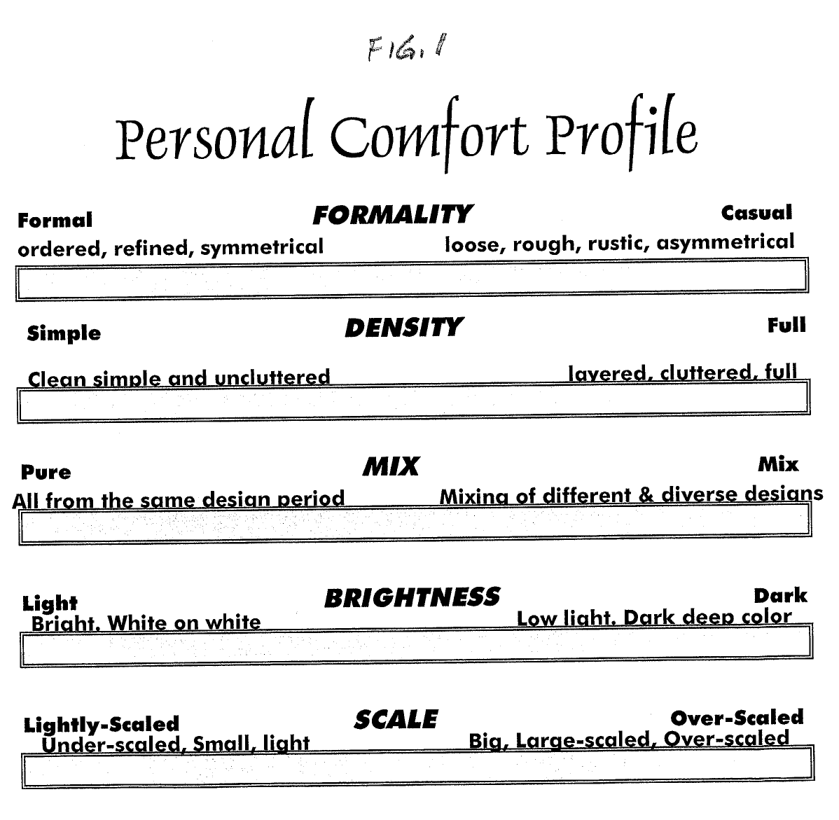

FIG. 1 is a diagram 100 of a typical personal style diagnostic system profile page according to one embodiment of the invention. The PSDS in one embodiment provides five style factors comprising a personal comfort profile. Each of the style factors has a range of levels within that factor that range between one end of the spectrum for that style to an opposite end. The five style factors and their ranges are shown in greater detail in the Figure as well as in Table 1 below.

TABLE 1

| Style Factor | First end of spectrum | Opposite end of spectrum |
|---|---|---|
| Formality | Formal | Casual |
| Density | Simple | Full |
| Mix | Pure | Mix |
| Brightness | Light | Dark |
| Scale | Lightly-Scaled | Over-Scaled |

Each of the styles has particular common language that further defines its spectrum. For example, within the Formality spectrum, formal includes such terms as ordered, refined, and symmetrical, while casual includes such terms as loose, rough, rustic, and asymmetrical. Within the Density spectrum, simple includes such terms as clean, simple, and uncluttered, while full includes terms such as layered, cluttered, and full. Within the Mix spectrum, pure includes terms such as “same design period,” while mix includes terms such as mixed, different, and diverse. Within the Brightness spectrum, light includes such terms as bright and white on white, while dark includes such terms as low light, dark, and deep color. Within the Scale spectrum, lightly-scaled includes such terms as under-scaled, small, and light, while over-scaled includes such terms as big, large-scaled, and over-scaled.

It should be seen that within the styles, the spectrum within each style from one end to another, allows a very large degree of individuality within a framework of a few easily understood and universal terms. It is this language of the personal style diagnostic system that allows its use to define, refine, and assist the customer in evaluating and effectively using his or her desires and wants to design an individualized room or home interior.

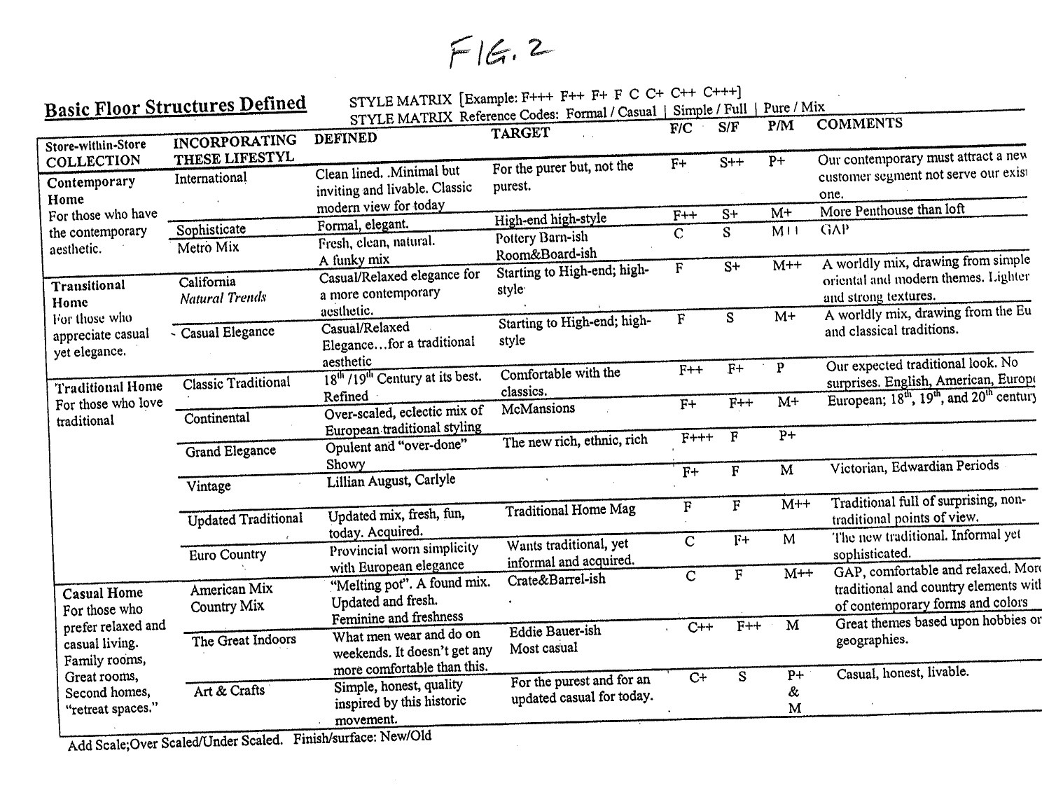

A chart showing some typical assignments of styles to basic room patterns and floor structures is shown in FIG. 2.

The few diagnostic tools on the market today attempt to fit people into a handful of generic descriptions. The personal style diagnostic system helps the consumer target the desired style within a range of a large number of distinct looks. The consumer can continually explore the various families and braches of these style factors to fine tune choices and create familiar families of personalities that come together to create a home. The PSDS empowers the consumer to confidently express desires through the learning and language experienced through use of the PSDS.

In one embodiment, a paper form personal style diagnostic test is provided for a customer. This paper form shows the customer various pieces of furniture, associating the customer's likes and dislikes with the common language of the personal style diagnostic system to allow the customer to define and refine his or her tastes and personal comfort profile. In one embodiment, the paper form is used in conjunction with a layout within the retail store of a variety of rooms tailored to varying styles.

In another embodiment, as has been mentioned, a retail furniture showroom is used in conjunction with the PSDS to further immerse the customer in the choices, and to allow the customer to see those choices in action. The retail store is utilized to reinforce the language, the structure, theories and philosophies of the PSDS. As the consumer gains familiarity with the PSDS, at the same time the customer gains familiarity with the retail store and with the concepts behind the selection and evaluation of furniture to create rooms. One experience builds upon and enriches the other. For example, while the abstract concept of density may be intuitively obvious and reinforced by the images associated with the diagnostic, to experience it in labeled room displays further reinforces and makes more real how high density or low density is defined.

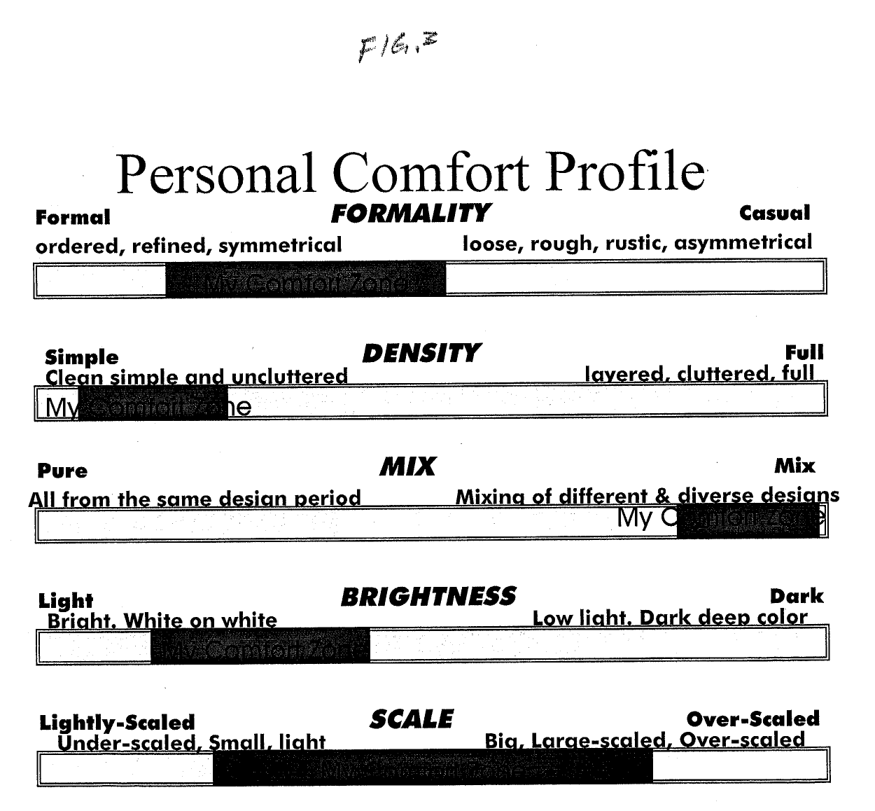

FIG. 3 is a diagram of a typical completed personal style diagnostic system profile. As can be seen from the Figure, a customer or consumer has completed a personal style diagnostic system questionnaire, by any of the methods described herein, and the personal style diagnostic system has assigned a comfort zone for each of the five style factors. Using this set of comfort zones for different style factors, the customer can be shown actual set up rooms, or virtual rooms or components for those rooms, that fit the personal style of the customer. Such a personal style is representative in this embodiment not of subjective personality typing, but instead is representative of actual likes and dislikes of the customer, in a variety of areas that cohese to a specific personal style. The permutations of personal style in the embodiments of the PSDS are vast, and allow for the broadest of tastes.

Individuals as well as couples or larger groups can alos make use of the PSDS in various embodiments. For example, group members in one embodiment take the PSDS diagnostic paper form individually for a particular room or the like. Then, the results are created, and overlapping areas may be found. These overlapping areas of style form the basis for the beginnings of a room design that has features all members can appreciate.

In one embodiment, a store is set up to have a number of different rooms, each of the rooms having its own style. The style of the rooms is comprised of a combination of five style factors, each factor having a range along a style factor spectrum from one end to another. In one embodiment, the style factors are formality, density, mix, brightness, and scale. Each of the style factors, as has been mentioned, has its own scale. The location along each style factor range is gathered through one or more of a number of methods, including personal preference choices by consumers looking at the rooms, marking or noting which they prefer) and comparing the preferences of the consumer versus a known profile for each of the rooms. Given this, a person's individual style or comfort profile is generated.

There are many possible combinations of style factors that affect personal comfort. Further, personal comfort can be different for the type of room the consumer wishes to design or have designed. In one embodiment, once the choices are made by a consumer marking or noting preferences, a computer program with an accessible database of categorized components is consulted. The categorized components each fall into an area of style, and in a range. For example, a formal dining room table falls at the formal end of the formality scale. For one consumer, who has a mix scale of mix, the chairs perhaps will be selected from a different or otherwise diverse design. On the other hand, for a consumer who is formal and pure, the chairs are likely selected come from the same design period.

The style factors allow the tailoring of a room ensemble to the myriad tastes of the consumer. This is easy to accomplish by using a common set of definitions across a number of different designs. For example, categorization is made within the database of pieces of furniture as to where on the formality, brightness, and scale styles each falls. The consumer's preferences, as determined through self evaluation, sales associate- or designer-assisted evaluation, or computer driven evaluation, are used to present possible combinations or individual pieces that may be used to form combinations. As the consumer selects more and more pieces, the style is refined based on type of room, or simply on changing or narrowing preferences.

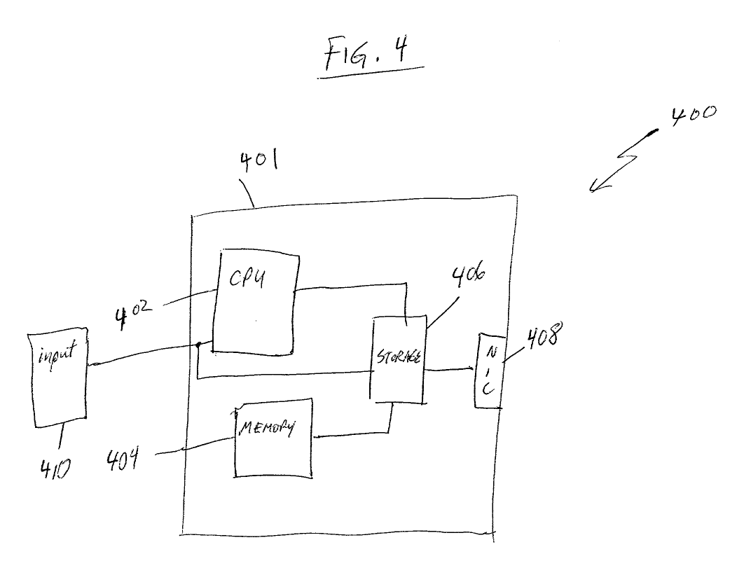

FIG. 4 shows one embodiment 400 of a personal style diagnostic system computer terminal. The system 100 comprises a computer 401 running computer programs on central processing unit 402 out of main memory 404, and may be transferred to main memory from permanent storage 406 via disk drive or CD-ROM drive when stored on removable media or via a network connection 108 or modem connection when stored outside of the computer 401, or via other types of computer or machine readable media from which it can be read and utilized. An input device or devices 410, such as a keyboard and mouse, allow the user to interact with the system. In other embodiments, a touch screen is used for an input device.

A computer program 412 runs on the system 400. In one embodiment, this computer program comprises machine readable instructions for causing the computer to perform a personal style diagnostic method. The method will be described in greater detail below. The machine readable instructions allow the program to consult a database containing defined furniture elements, each of the defined elements fitting within a particular style type or framework.

In various embodiments, the personal style diagnostic system operates in various ways. In one embodiment, as described above, a computer program assists the user in evaluation of personal style. This embodiment uses a computer program having access to a categorized and defined database of individual furniture components, wherein each of the components is predefined as having certain characteristics within one or more of the style factors described above. The customer views pieces within a user selectable area, such as dining room, bedroom, or the like, or can simply view a random sampling of pieces. The user uses the input device of the computer, such as a touch screen, mouse, keyboard, or combination thereof, to express likes and dislikes about each piece, or simply in one embodiment indicates a positive or negative response. In another embodiment, the customer enters a number or scale indicative of a preference from strong positive to strong negative. The computer program tabulates user responses to various pieces, and compares them with logical code to the assigned or predefined attributes and style factor spectrum ranges for each piece, and tracks customer preferences.

As the customer evaluates more and more pieces of furniture, the program refines the likes and dislikes of the customer, and in one embodiment adapts the selections to be viewed to refine even further the likes and dislikes of the customer. For example, if a pattern of responses by the customer indicates that the customer prefers a full density room in nearly all or all instances, but formality is less well developed, the program chooses full density items for viewing, but shows formality items along the entire spectrum to refine the customer's tastes with respect to formality. In this way, the customer learns what he or she likes and dislikes, and can begin to associate the common language of the personal style diagnostic system with actual furniture styles. This knowledge that the customer gains further assists the customer by providing the customer with a basis from which to work with a designer or sales associate, without the influence of the designer or sales associate in the initial evaluation process of determining likes and dislikes, and a personal comfort profile or style preference.

In another embodiment, the computer programs such as the PSDS described above are implemented in an intelligent agent. This intelligent agent operates a system for evaluation of personal style, by consulting a predefined database, and by operating on a computer a fuzzy logic set, a neural network, or the like, to adapt and learn from user input the actual personal style of the user through a series of measured responses and application of those responses to known style factors and range factors within those style factors.

In another embodiment, a mass storage media such as a compact disk read only memory (CD-ROM) or digital video disk (DVD) is provided with which the consumer need not be present in the store to take the personal style diagnostic. This embodiment allows the consumer to actually be present in the room desired to be decorated, and to assist in visualization of the individual pieces and how they fit into the room. Such as system is also amenable to publication on the Internet, for example on a web site or the like.

In another embodiment, the definition and visual representations of the PSDS are reinforced in a series of brochures that are organized by style realm and lifestyle. Once the consumer has gone through the diagnostic process the customer can pick up their selected brochures pertaining to the styles indicated as preferred.

Trained sales personnel and designers are also available in one embodiment to assist consumers. The trained designer or sales associate can direct the consumer how to begin, emphasizing the personal nature of furniture shopping and of personal style. This lower pressure approach helps to put the customer at ease, and creates an environment conducive to enjoying the selection and evaluation process. In addition, the more knowledgeable the consumer, the more assistance a sales associate or designer can later offer.

Trained sales associates and designers who fully utilize, support, compliment, and leverage the diagnostic tools of the PSDS and the resulting recommendations further enhance the furniture selection process. The PSDS is not necessarily a replacement for the professional consultation and experience but rather a bridge that brings the consumer and the professional together.

With the PSDS available the role of the sales associate and interior designer is enhanced, and in some cases transformed. For the consumer who has begun to use the PSDS either through the retail store or the computer or paper versions, the consumer has begun to qualify their needs and wants and they share a common language with the sales associate or designer. With a deeper knowledge of the personal style approach store personnel demonstrate a valuable role as counselor and consultant in finalizing the definition process, refining it to the customer's personal needs, adjusting it to each mood for each room in the house and specifying the product that delivers on the vision.

It should be understood that further style factors may be included in the PSDS, or that the PSDS is applicable to further environments that are subject to a personal style, including by way of example and not by way of limitation, landscaping, home design, and the like.

In another embodiment, the PSDS is used in conjunction with search and edit system and virtual room visualization programs. Each of the PSDS, the search and edit, and the virtual room visualization programs utilizes the same vocabulary and definition system.

### Search and Edit System

One embodiment of the search and edit system contains a database of content according to the style factors and spectra described in greater detail above. Once the PSDS is utilized, as new furniture comes out, it will be classified according to the PSDS. In one embodiment, individual manufacturers provide PSDS evaluations, allowing the database to span a large or total market segment with little or no data entry into the PSDS.

### Virtual Room Visualization

A virtual room visualization system embodiment combines with the PSDS and optionally the search and edit programs. The virtual room visualization allows the customer to start with a basic look, with a bare room of the dimensions of the desired room to be decorated or furnished, and interfaces with the PSDS to provide selections appropriate to the personal comfort profile or personal style of the customer. The parameters of the PSDS applied to the room provide a starting point for modification and visualization. Based upon personal style parameters from the PSDS, in one embodiment, a basic template of a completed virtual room is shown, and the customer has the option to choose among a variety of pre-identified compatible products and then fine tune for personal style and taste. The end result is a diagram and virtual presentation of the room as it can be expected to look given the choices.

In other embodiments, the PSDS, search and edit, and room visualization programs are presented in combination or separate. Further, the PSDS in one embodiment provides a downloadable set of images that are then usable in various commercially available room visualization programs.

The methods described herein may be implemented in whole or in part in various embodiments in a machine readable medium comprising machine readable instructions for causing a computer such as is shown in FIG. 1 to perform the methods. The computer programs run on the central processing unit 102 out of main memory 104, and may be transferred to main memory from permanent storage 106 via disk drive or CD-ROM drive when stored on removable media or via a network connection 108 or modem connection when stored outside of the computer 100, or via other types of computer or machine readable media from which it can be read and utilized.

Such machine readable media may include software modules and computer programs. The computer programs may comprise multiple modules or objects to perform the methods in Figures or the functions of various apparatuses of Figures. The type of computer programming languages used to write the code may vary between procedural code type languages to object oriented languages. The files or objects need not have a one to one correspondence to the modules or method steps described depending on the desires of the programmer. Further, the method and apparatus may comprise combinations of software, hardware and firmware as is well known to those skilled in the art.

### Conclusion

When a sales associate or designer and a customer share a common language and a common understanding of terms and style evaluation processes, and have defined the customer's personal style and needs together, the customer and sales associate are able to communicate more effectively, on a more level field. Knowledge of one's personal style and tastes, and the ability to express those styles and tastes in a common and understandable language, create a confident consumer who is more vitally involved in the selection of home furnishings. There is a value added to the relationship between sales associate or designer and customer that creates a creative and confident partnership.

To create a personal style, the personal style diagnostic system evaluates tastes and personal style based on a number of factors that are not necessarily dependent upon personality. Instead, they are based on commonly identifiable and understandable categorized selections. With such a vast variety of combinations within the predefined style factors, and a large database of possible choices, the PSDS allows the creation of a room to fit anyone's style, no matter what it is.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

After paragraph 0033, add Table 2 as follows:

TABLE 2
Basic Floor Structures Defined

| Store-Within- | | | | | | | |
|---|---|---|---|---|---|---|---|
| Store | Incorporating | | | | | | |
| COLLECTION | these lifestyles | DEFINED | TARGET | F/C | S/F | P/M | COMMENTS |
| Contemporary | International | Clean lined. | For the purer | F+ | S++ | P+ | Our |
| Home | | Minimal but | but, not the | | | | contemporary |
| For those who | | inviting and | purest | | | | must attract a |
| have the | | livable. | | | | | new customer |
| contemporary | | Classic | | | | | segment not |
| aesthetic. | | modern view | | | | | serve our |
| | | for today | | | | | existing one. |
| | Sophisticate | Formal, | High-end | F++ | S+ | M+ | More |
| | | elegant | high-style | | | | Penthouse than |
| | | | | | | | loft |
| | Metro Mix | Fresh, clean, | Pottery Barn- | C | S | M++ | GAP |
| | | natural. A | ish, | | | | |
| | | funky mix | Room & Board- | | | | |
| | | | ish | | | | |
| Transitional | California | Casual/Relax- | Starting to | F | S+ | M++ | A wordly mix, |
| Home | Natural Trends | ed Elegance | High-end; | | | | drawing from |
| For those who | | for a more | high-style | | | | simple oriental |
| appreciate casual | | contemporary | | | | | and modern |
| yet elegance. | | aesthetic | | | | | themes. Lighter |
| | | | | | | | and strong |
| | | | | | | | textures |
| | Casual | Casual/Relax- | Starting to | F | S | M+ | A wordly mix, |
| | Elegance | ed Elegance | High-end; | | | | drawing from |
| | | . . . for a | high-style | | | | the European |
| | | traditional | | | | | and classical |
| | | aesthetic | | | | | traditions. |
| Traditional | Classic | 18th/19th | Comfortable | F++ | F+ | P | Our expected |
| Home | Traditional | Century at its | with the | | | | traditional |
| For those who | | best. Refined | classics | | | | look. No |
| love traditional | | | | | | | surprises. |
| | | | | | | | English, |
| | | | | | | | American, |
| | | | | | | | European |
| | Continental | Over-scaled, | McMansions | F+ | F++ | M+ | European; |
| | | eclectic mix | | | | | 18th, 19th, and |
| | | of European | | | | | 20th century |
| | | traditional | | | | | |
| | | styling | | | | | |
| | Grand | Opulent and | The new rich, | F+++ | F | P+ | |
| | Elegance | “over-done” | ethnic, rich | | | | |
| | | Showy | | | | | |
| | Vintage | Lillian | | F+ | F | M | Victorian, |
| | | August, | | | | | Edwardian |
| | | Carlyle | | | | | periods |
| | Updated | Updated mix, | Traditional | F | F | M++ | Traditional full |
| | Traditional | fresh, fun, | Home Mag | | | | of surprising, |
| | | today. | | | | | non-traditional |
| | | Acquired. | | | | | points of view |
| | Euro Country | Provincial | Wants | C | F+ | M | The new |
| | | worn | traditional, | | | | traditional. |
| | | simplicity | yet informal | | | | Informal yet |
| | | with | and acquired. | | | | sophisticated. |
| | | European | | | | | |
| | | elegance | | | | | |
| Casual Home | American Mix, | “Melting | Crate & Barrel- | C | F | M++ | GAP, |
| For those who | Country Mix | pot.” A found | ish | | | | comfortable |
| prefer relaxed and | | mix. Updated | | | | | and relaxed. |
| casual living. | | and fresh. | | | | | More |
| Family Rooms, | | Feminine and | | | | | traditional and |
| great rooms, | | freshness | | | | | country |
| second homes, | | | | | | | elements with |
| “retreat spaces.” | | | | | | | contemporary |
| | | | | | | | forms and |
| | | | | | | | colors. |
| | The Great | What me | Eddie Bauer- | C++ | F++ | M | Great themes |
| | Indoors | wear and do | ish, Most | | | | based upon |
| | | on weekends. | casual | | | | hobbies or |
| | | It doesn't get | | | | | geographies. |
| | | and more | | | | | |
| | | comfortable | | | | | |
| | | than this. | | | | | |
| | Arts & Crafts | Simple, | For the purest | C+ | S | P+ & | Casual, honest, |
| | | honest, | and for an | | | M | livable. |
| | | quality | updated | | | | |
| | | inspired by | casual for | | | | |
| | | this historic | today | | | | |
| | | movement | | | | | |

What is claimed:

1. A method for determining a personal comfort profile for a furniture shopper, comprising:
defining a plurality of style factors, each style factor having a range of components within the style factor;
evaluating the shopper's style factors along the range for each style factor; and
assigning a composite style based on the defined style factors and the user's style factors.

2. The method of claim 1, wherein defining comprises:
placing a style and spectrum within each style on a plurality of individual furniture components.

3. The method of claim 2, wherein placing a style and spectrum comprises:
assigning each individual furniture component to at least one style factor, the style factors comprising formality, brightness, and scale.

4. The method of claim 3, wherein placing a style and spectrum further comprises:
assigning each individual furniture component within a spectrum range of each style factor to which it is assigned.

5. The method of claim 1, wherein evaluating comprises:
presenting the shopper with a plurality of furniture components pre-assigned to at least one of the plurality of style factors;
querying the shopper's reaction to each of the presented furniture components; and
tabulating the shopper's reactions to assign a personal style based on pre-assigned style factors for the presented furniture components.

6. The method of claim 5, wherein evaluating further comprises:
categorizing the plurality of furniture components in a plurality of style factor areas comprising formality, density, mix, brightness, and scale.

7. The method of claim 5, wherein categorizing in formality further comprises ranking along a range from formal to casual.

8. The method of claim 5, wherein categorizing in density further comprises ranking along a range from simple to full.

9. The method of claim 5, wherein categorizing in mix further comprises ranking along a range from pure to mixed.

10. The method of claim 5, wherein categorizing in brightness further comprises ranking along a range from light to dark.

11. The method of claim 5, wherein categorizing in scale further comprises ranking along a range from lightly-scaled to over-scaled.

12. The method of claim 1, wherein the method is executed in a machine readable medium comprising machine readable instructions for causing a computer to perform the method.

13. A method for evaluating personal style of a customer shopping for furniture, comprising:
creating a plurality of rooms, each room having a style identified using style factors comprising formality, density, mix, brightness, and scale;
querying the customer regarding preferences for or against each of the plurality of rooms;
applying customer responses to the style of each room; and
classifying the customer's personal style based on a compilation of the customer responses applied to the known style of each room.

14. A personal style diagnostic system (PSDS), comprising:
a computer;
a program resident on the computer, the program comprising machine readable instructions for causing the computer to perform a method comprising:
defining a plurality of style factors, each style factor having a range of components within the style factor;
evaluating the user's style factors along the range for each style factor; and
assigning a composite style based on the defined style factors and the user's style factors.

15. The PSDS of claim 14, and further comprising a data structure containing a plurality of predefined ensembles evoking a plurality of style factors for visualization by a user.

16. The PSDS of claim 14, wherein the style factors are selected from a group consisting of formality, density, mix, brightness, and scale.

17. A data structure of furniture components, each of the furniture components classified according to a predefined set of styles and ranges with those styles.

18. The data structure of claim 17, wherein the predefined set of styles comprises:
a formality style having a range from formal to casual;
a density style having a range from simple to full;
a mix style having a range from pure to mixed;
a brightness style having a range from light to dark; and
a scale style having a range from lightly-scaled to over-scaled.

19. The data structure of claim 17, wherein the data structure is stored in a database.

20. A method for quantifying furniture needs and wants of a consumer, comprising:
defining a common language of terminology for use in style evaluation;
defining a plurality of styles, each style having a plurality of factors comprising formality, density, mix, brightness, and scale;
assigning a plurality of individual furniture components each to at least one of the plurality of styles, and within a range spectrum within each style;
presenting the consumer with a subset of the plurality of individual furniture components; and
evaluating a most common consumer preference along the range spectrum for each of the plurality of styles.

21. The method of claim 20, wherein assigning in formality further comprises ranking along a range spectrum from formal to casual.

22. The method of claim 20, wherein assigning in density further comprises ranking along a range spectrum from simple to full.

23. The method of claim 20, wherein assigning in mix further comprises ranking along a range spectrum from pure to mixed.

24. The method of claim 20, wherein assigning in brightness further comprises ranking along a range spectrum from light to dark.

25. The method of claim 20, wherein assigning in scale further comprises ranking along a range spectrum from lightly-scaled to over-scaled.

26. The method of claim 20, wherein the method is executed in a machine readable medium comprising machine readable instructions for causing a computer to perform the method.

27. An intelligent furniture style selection agent, comprising:
a computer;
a database of defined furniture components, each defined component identified within a range of at least one style category;
a computer program to query a user regarding tastes for a subset of the defined furniture components and to interface; and
an intelligent logic block to evaluate and refine style based on responses to the queries presented by the program.

28. A personal style diagnostic system (PSDS), comprising:
an evaluation tool using a defined plurality of style factors to assign a user within a range for each of the style factors computer.

29. The PSDS of claim 28, wherein the plurality of style factors comprises:
a formality style having a range from formal to casual;
a density style having a range from simple to full;
a mix style having a range from pure to mixed;
a brightness style having a range from light to dark; and
a scale style having a range from lightly-scaled to over-scaled.
